(19) United States
(12) Patent Application Publication
(10) Pub. No.: US 2010/0107333 A1
(43) Pub. Date: May 6, 2010

(54) FABRIC, FUNCTIONAL MATERIAL, OR MAT

(76) Inventor: Hartmut Ortlieb, Heilsbronn (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 12/513,127

(22) PCT Filed: Oct. 18, 2007
(86) PCT No.: PCT/DE07/01864

§ 371 Date: Dec. 10, 2009

(30) Foreign Application Priority Data
Nov. 13, 2006 (DE) 10 2006 053 666.5

(51) Int. Cl. A47G 9/08; B32B 7/08; B32B 38/00; B32B 1/02

(52) U.S. Cl. 5/413 R; 428/221; 156/93; 428/34.1

(57) ABSTRACT

Fabric, functional material, or mat, consisting of cover layers with threads placed between as spacers, whereby the threads are attached to pairs of spacer grips, and these spacer grips are connected to an upper and a lower cover layer.

### CROSS REFERENCE TO RELATED APPLICATIONS

This application claims priority from International (PCT) Patent Application No. PCT/DE2007/001864, filed Oct. 18, 2007, and published as International Patent Publication No. WO 2008/058498 A1 on May 22, 2008; the entire contents of which are herein incorporated fully by reference; which in turn claims priority from German Patent Application No. 10 2006 053 666.5 filed on Nov. 13, 2006.

### FIGURE FOR PUBLICATION

FIG. 2.

### BACKGROUND OF THE INVENTION

1. Field of the Invention

The present invention relates to a fabric, functional material, or a mat consisting of cover layers with threads placed between as spacers. More specifically, the present invention relates to a fabric, functional material, or a mat consisting of cover layers with threads placed between as spacers and where the threads are attached to pairs of at least one strip or cut material which are connected onto an upper and a lower cover layer.

2. Description of the Related Art

The related art involves fabrics and functional materials which are manufactured as various goods in varied embodiments and processing forms, such as: sleeping bags, covers; upholstery; and, recliner mats, as well as inflatable mats.

What is not appreciated by the prior art is that appropriate properties go hand in hand with corresponding disadvantages. For example, often inflatable mats are equipped with thick upper and lower layers, causing them to be relatively heavy. Such mats provide very meager insulation for the most part, and at least in certain processing zones have considerable cutoffs.

Accordingly, there is a need for an improved fabric, functional material or a mat that is lighter than previous embodiments and whose good insulation performance is combined with high stability.

### ASPECTS AND SUMMARY OF THE INVENTION

One aspect of the present invention is to provide an improved fabric, functional material or a mat that is lighter than previous embodiments and whose good insulation performance is combined with high stability.

Another aspect of the present invention is to provide a fabric wherein at least one of the cover layers of the fabric is a layer with a functional membrane, through which, for example, a fabric results that is sealed against the wind on one side, but retains a breathing capacity on the other side.

According to an embodiment of the present invention there is provided a fabric, functional material, or a mat consisting of cover layers with threads placed in between is applied as a spacer, whereby the threads are applied to pairs of spacer grips and these spacer grips are secured on an upper and a lower cover layer.

According to a preferred embodiment of the invention, at least one of the cover layers of the fabric is a layer with a functional membrane, through which, for example, a fabric results that is sealed against the wind on one side, but retains a breathing capacity on the other side. Base layers such as GORE-TEX™ or SYMPATEX™ can form the outer layers of the invention-specific fabric, whereby a fabric results which can be used as a lining for clothing, sleeping bags or covers.

Another preferred embodiment makes provision to form the cover material from a fabric with an adhesive layer and two polyurethane foils. By making one or both of the cover layers of a fabric out of water and gas-impenetrable material, a cover is obtained with a watertight lower side or a mat impenetrable to gas and water, which preferably is able to be inflated in this embodiment form.

A preferred embodiment of a mat is equipped between the two cover layers, between the spacer grip with a filler material. The filler material, preferably a material that is light and has good insulation qualities along with that, such as fleece batting or down, or another suitable material, preferably is penetrated in the interior of the mat between the two cover layers by the threads. The threads, that form the spacers, preferably are sewn through the spacer grip pairs, whereby preferably monofil chain stitching with loop formation is used, and with the loops, the distance between the spacer grips is determined. The spacer grips are implemented as upper and lower narrow pairs of strips attached to the cover layers, which, according to a preferred embodiment, are pairs of strips from 10 to 40 mm in width.

Owing to this preferred embodiment of the filler layer penetrated by the threads, whereby the threads are attached onto pairs of spacer grip strips, a very light mat or fabric is obtained with optimal insulating qualities. In its interior, the mat has a space completely provided with filler material, which is not interrupted or subdivided, as many known mats are, by webs, which mostly are used as connectors and spacers.

According to a further preferred version, the threads are woven between and through the two spacer grips; this occurs at a desired interval length between the spacer grips placed above and below. The spacer grips, or the spacer grip strips, are preferably attached on a cover layer of the fabric or the mat by adhesives. The spacer grips themselves are likewise equipped with an adhesive, especially in the area through which the threads and sewn or woven. Preferably a hot-melt adhesive is used as the adhesive, and preferably has a low melting point and is capable of being air-cured.

Owing to this preferred embodiment, the fabric, or the mat, can be fixed with the threads after production, i.e. after gluing of the spacer grips onto the cover layers, after the filler material is applied and the spacer connections joined. Fixation occurs through heating and pressing of the sandwich structure consisting of the cover layer, filler material of spacer grips and threads above the melting temperature of the adhesive, but below the melting temperature of a coating of the cover layer. In the process, the adhesive melts in the spacer grips and the thread or web places of the threads running through this spacer grip are surrounded by this emerging adhesive and fixed. At the same time, the filler material is also glued onto the adhesion sites via the adhesive emerging laterally at these sites.

The described spacer grips preferably are formed from multiple strips, which run along, or transverse to the fabric or the mat, or, if the shape or structure of the fabric or the mat requires it, run in other geometric arrangements on the upper and lower layer. Additionally, the spacer grips, or the preferably used spacer grip strips, are preferably made of a fleece made of monofils, which has been revealed to be optimal.

If the described fabric or functional material is embodied as a mat, especially as an inflatable mat in which the upper and lower cover layer is made of a material impenetrable by gas, and whereby the mat has at least one valve to admit air, according to one preferred embodiment, the filler material has a self-inflating effect for the mat. The filler material can be an open-pored material such as foam, or only a filler material infiltrated by a foam, to achieve the inflation effect. The foam employed preferably is fixed via the seams between the two cover layers. An invention-specific corresponding mat is preferably bonded on its edge sides, with the edges preferably bonded at high frequencies.

A fabric, functional material or a mat according to the embodiments described can preferably be manufactured to be endless with longitudinal seams and can be brought to the desired length with transverse bondings.

With the transverse bondings, preferably an additional strip of hot-melt is applied to stop the capillary action of spacer grips and threads by encapsulating the threads with the hot melt, through which these locations also are sealed. The additional hot melt strip, placed in use with transverse bonding, is embodied so that the threads are pressed off when the bonded seam is transversely bonded; and, thus, the threads and/or the seams do not get onto the bonding site and get bonded into them, where they could lead to sites of seal integrity loss.

The fabric, functional material or the mat in the named embodiment forms and versions is configured among other things as a sleeping bag or part of a sleeping bag. In the version as a sleeping bag, the materials of the cover layer are designed to be appropriately light and capable of breathing, or a layer can be designed as a so-called functional membrane. With such a sleeping bag, the filler material preferably is down or an appropriately insulating fleece material.

For design as an air mattress or a combination of air mattress with an integrated sleeping bag, a cover layer reinforced below suggests itself and a lighter, upper design with a breathing function of the upper cover layer. With this, the filler material preferably is a foam or a material infiltrated with foam, to afford the mattress the ability to be blown up.

The described design of the fabric for a sleeping bag is preferably also suitable to make an interior lining from it for clothing, or to produce clothing entirely from this fabric, especially clothing with an augmented demand for insulation, such as winter clothing (e.g., ski clothing).

An invention-specific air mattress, with or without the described integrated sleeping bag, is preferably adapted to the body contours of a human being; and, for one, to use as little material as possible so as to enable a light weight design, so that optimal lying and thermal comfort are possible.

The invention-specific designed mat, especially an inflatable mattress with an interior filler, is preferably also designed as a protective sheath, whereby such a mat for can absorb impacts owing to its interior filler and insulating air cushion. Additionally, the insulating interior filler represents a protection against cooling off.

A mat thus embodied as an insulator and protective item is preferably used as an insulator and protector for a container, to provide the container with the best possible insulation; and, at the same time, to protect it from impacts collision (e.g., if dropped).

An invention-specific fabric, functional material, or a mat is preferably manufactured by longitudinal sewing of multiple, preferably hot-melt-coated, pairs of spacer grips, preferably equipped with an intermediate layer of fleece batting, or down, and with appropriate cover layers, which are sewn and/or joined in endless fashion longitudinally and transversely.

By heating and, if necessary, compression of this structure (i.e., in a hot press), the seams, the interior filler, and the threads are equipped with adhesive and/or coated, and the product can be equipped with one or more valves as a mattress.

The above, and other aspects, features and advantages of the present invention, will become apparent from the following description read in conjunction with the accompanying drawings, in which like reference numerals designate the same elements.

### BRIEF DESCRIPTION OF THE DRAWINGS

FIG. 1 shows a fabric, functional material, or a mat in accordance with the present invention.

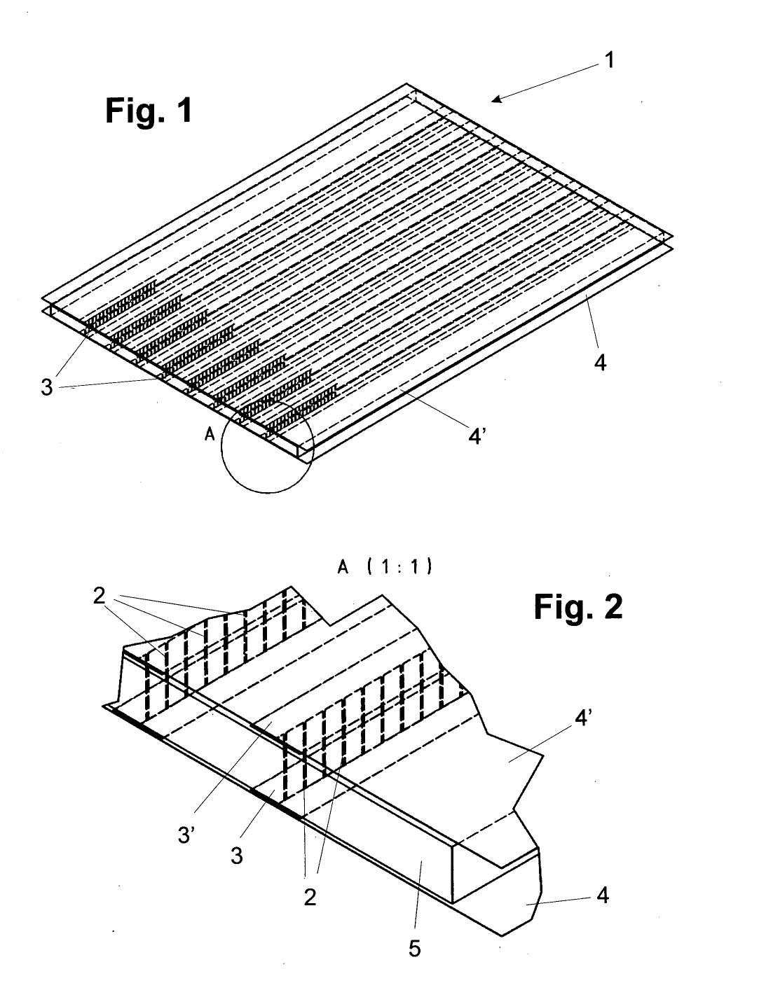

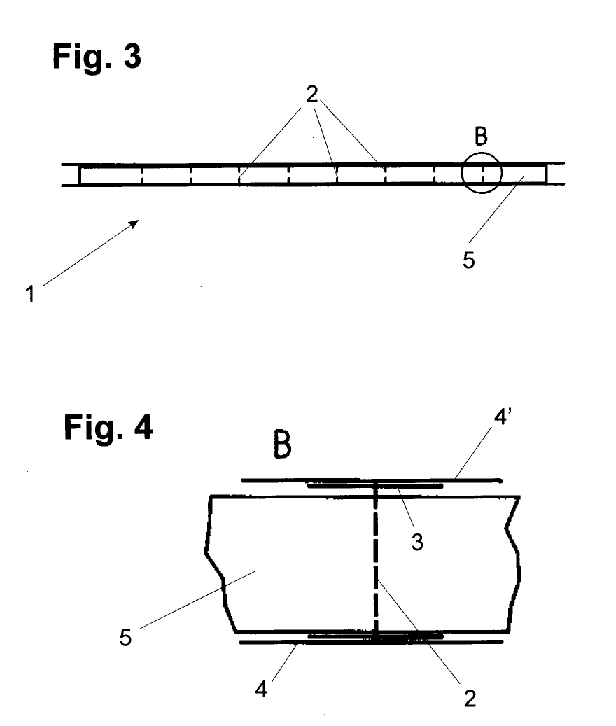

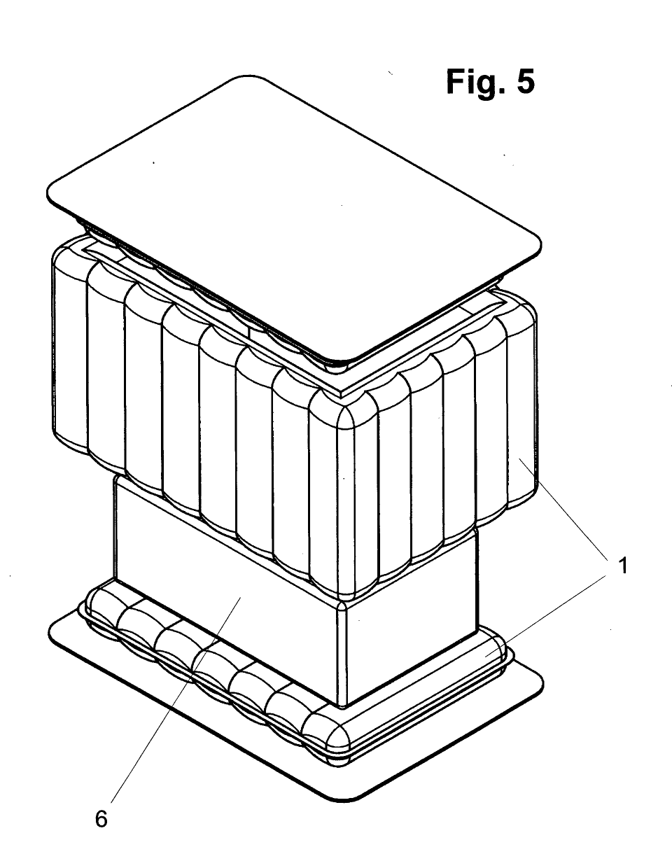

FIG. 2 shows an enlargement of an area of the fabric, functional material, or the mat of FIG. 1.

FIG. 3 shows a cross section through the fabric, functional material, or the mat of FIG. 1.

FIG. 4 shows an enlargement of a select area of FIG. 3.

FIG. 5 shows a container using a mat, designed in accordance with the present invention, as a protective mat.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

FIG. 1 shows a fabric, functional material, or a mat, on which spacer grip strips 3 are longitudinally attached on an upper 4′ and a lower cover layer 4. Here, the mat is shown as not yet closed or joined on the edge side, and also not yet cut into sections longitudinally by transverse bonding.

FIG. 2 shows an enlargement of a segment of the mat shown in FIG. 1, in which the threads 2 are shown used as spacers, which show the interval between the two spacer grips attached above 3′ and below 3. Between the two cover layers 4′ and 4, a filler material 5 is inserted, which has an insulating function and provides a self-inflating function to the embodiment as a mat.

FIG. 3 and FIG. 4, in turn, show a cross section through a fabric, functional material, or a mat, which consists of the two cover layers 4′, 4 and the upper and lower spacer grips 3 applied between them. The interval between the two cover layers for a mattress to be inflated is limited by the threads 2. A filler material inserted between the cover layers 4′ and 4 is penetrated by the threads 2 and is fixed with them along with the adhesive employed.

FIG. 5 shows a container 6 which is protected against impacts by means of the invention-specific mat 1 in an appropriate size and, at the same time, is protected by the mat's insulating qualities against cooling off.

After the preferred embodiments of the invention have been described in reference to the appended drawings, it is emphasized that the invention is not limited to these exact embodiments, and that various alterations and modifications can be carried out by a specialist, without deviating from the scope of the invention as it is defined in the appended claims.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1.-44. (canceled)

45. Fabric, functional material, or mat, consisting of a plurality of cover layers with a plurality of threads placed therebetween as spacers, and characterized in that:
(a) said plurality of threads being attached to one or more pairs of at least one strip, or a cut piece of material to form a plurality of spacer strips; and
(b) said spacer strips are connected onto an upper and a lower cover layer.

46. Fabric, functional material, or mat according to claim 45, characterized in that:
(a) at least one of said cover layers is designed as a material sealed against a gas or a fluid; and
(b) at least one of said upper and lower cover layers are made of a material consisting of a fabric with an adhesive layer and two polyurethane foils.

47. Fabric, functional material, or mat according to claim 45, characterized in that the fabric, functional material, or mat is equipped with a filler material between said spacer strips.

48. Fabric, functional material, or mat according to claim 45, characterized in that said filler material is penetrated between said spacer strips by a subset of said plurality of threads.

49. Fabric, functional material, or mat according to claim 47, characterized in that said filler material is a fleece batting or down.

50. Fabric, functional material, or mat according to claim 45, characterized in that a seam for creating an interval is designed as a monofil chain stitching with loop formation.

51. Fabric, functional material, or mat according to claim 45, characterized in that said subset of said plurality of threads is sewn through said pairs of spacer strips.

52. Fabric, functional material, or mat according to claim 45, characterized in that said plurality of spacer grips is equipped with an adhesive.

53. Fabric, functional material, or mat according to claim 52, characterized in that each of said plurality of threads is fixed to said spacer strips with said adhesive.

54. Fabric, functional material, or mat according to claim 52, characterized in that each of said plurality of spacer strips is fixed on said cover material with said adhesive.

55. Fabric, functional material, or mat according to claim 52, characterized in that:
(a) activation of said adhesive occurs through heating and pressing of the fabric, functional material, or mat above the melting temperature of said adhesive, but below the melting temperature of the coating of said cover layer; and
(b) that said adhesive has a low melting point that cures in air.

56. Fabric, functional material, or mat according to claim 45, characterized in that each of the plurality of spacer strips are designed from a fleece made of monofils.

57. Fabric, functional material, or mat according to claim 47, characterized in that said filler material has a self-inflating capacity for said mat.

58. Fabric, functional material, or mat according to claim 45, characterized in that said mat is equipped with at least one valve.

59. Fabric, functional material, or mat according to claim 45, characterized in that said mat is joined on an edge side.

60. Fabric, functional material, or mat according to claim 45, characterized in that the fabric, functional material, or mat is designed as part of a sleeping bag or as a sleeping bag.

61. Fabric, functional material or mat according to claim 45, characterized in that the fabric, functional material or mat is designed as an inner lining for a piece of clothing.

62. Fabric, functional material, or mat according to claim 45, characterized in that said mat is designed as a protective sheath and/or insulator and impact protector.

63. Fabric, functional material, or mat, consisting of an upper cover layer and a lower cover layer with a plurality of threads placed therebetween, and comprising:
(a) a plurality of spacer strips formed from said plurality of threads being attached to one or more pairs of at least one strip, or a cut piece of material; said spacer strips being connected onto an upper and a lower cover layer; and
(b) a filler material between said spacer strips; said filler material having a self-inflating capacity for said mat.

64. A procedure for manufacturing a fabric, functional material, or mat according, comprising the steps of:
(a) continuous longitudinal sewing of multiple pairs of spacer strips with an intermediate layer of fleece batting or down addition of cover layers;
(b) manufacturing or joining of longitudinal and lateral seams; and
(c) heating of the structure with hot presses and, if necessary, attachment of one or more valves.
